(19) United States
(12) Patent Application Publication
(10) Pub. No.: US 2002/0198640 A1
(43) Pub. Date: Dec. 26, 2002

(54) Automatic vehicle logging system and method

(76) Inventors: Narayan L. Gehlot, Sayreville, NJ (US); Victor B. Lawrence, Holmdel, NJ (US)

Correspondence Address: LAW OFFICE OF JOHN LIGON, 505 HIGHLAND AVENUE, P.O. BOX 43485, UPPER MONTCLAIR, NJ, 07043, US

(21) Appl. No.: 09/891,644

(22) Filed: Jun. 25, 2001

(51) Int. Cl. G06F 19/00

(52) U.S. Cl. 701/35

(57) ABSTRACT

A camera may be disposed near a license plate receiving portion of a vehicle and samples of image data obtained by the camera are stored in a storage unit. The storing of image samples only begins when the vehicle comes close to another vehicle or object, or when the brakes are forcefully activated. The rate at which the samples are stored may be varied as a function of the distance between the vehicle and another object, such as or example, a vehicle. The storing of image samples ends when the storage unit is full after the occurrence of an accident has been detected by a detector such as an impact detector, a hard-braking detector, an airbag inflation detector, a proximity detector or a sound detector. The stored image data, along with other saved data may be accessed by a person such as a police officer or insurance agent.

### FIELD OF THE INVENTION

The present invention is directed to the field of vehicle logging systems.

### BACKGROUND OF THE INVENTION

Many vehicle accidents occur every day. Obtaining data related to a vehicle accident is important for purposes of assigning responsibility, settling insurance claims, providing evidence for court cases and designing vehicle improvements to reduce the occurrence of future accidents.

To obtain data related to a vehicle accident, systems have been created whereby a camera or other image capturing device is placed on a vehicle and images obtained from the camera are periodically sampled and stored in a memory device. The sampled images are stored sequentially in a memory device that holds a certain number of images, and when the memory device becomes full of images, the process repeats and continues with the first image being overwritten with a new image. The sampling of visual images continues until an accident occurs, and then the sampling of images ends when the memory device becomes full. In this manner, a visual record of the events leading up a vehicle accident may be recorded and referred to after the accident.

A shortcoming of these methods of obtaining accident data is that the camera is positioned within the cockpit, or occupant area of the vehicle. A camera positioned within the cockpit of a vehicle may have an obstructed view of an accident and may not be able to view, for example, a license plate on another vehicle. Other drawbacks of a cockpit mounted camera are that the vehicle operator's view may be obstructed, and cameras within the cockpit may provide a poor aesthetic appearance, and that the cameras may be blocked or disabled by occupants of the vehicle. Additionally, cameras mounted within the cockpit, such as, for example, on a rear view mirror, may be subject to vibrations that may limit their effectiveness.

Another shortcoming of these systems is that by continuously viewing, sampling and storing visual data on a full-time basis, the components of the system are subjected to relatively high wear and tear, and the life of the components of the system may be subject to a relatively short life or mean time between failures.

Another shortcoming of these systems is that the sampling rate is fixed such that the image storage rate is not related to the proximity of other objects or vehicles or the likelihood that an accident will occur.

### SUMMARY OF THE INVENTION

The present invention is directed to an automatic vehicle logging system. A camera is disposed on a vehicle and samples of image data obtained by the camera are stored in a storage unit. The camera may be disposed on a license plate or near a license plate receiving portion of the vehicle, or elsewhere on the vehicle. The storing of image samples only begins when the vehicle comes close to another vehicle or object, or when the brakes are forcefully activated. The rate at which the samples are stored may be varied as a function of the distance between the vehicle and another object, such as or example, another vehicle. The storing of image samples ends when the storage unit is full after the occurrence of an accident has been detected by a detector such as an impact detector, a hard-braking detector, an airbag inflation detector, a proximity detector or a sound detector. A person such as a police officer or insurance agent may access the stored image data, along with other saved data.

Alternatively, more than one camera may be used. For example, cameras may be positioned at front and rear license plate receiving portions of a vehicle. The cameras may be disposed in vehicle lights in the front or rear of the vehicle, or may be disposed on a vehicle license plate. Also, the stored data may include additional vehicle related data in addition to the stored image data.

By having a camera positioned near the license plate receiving portion of the vehicle, the bumper portion of the vehicle or the headlight/taillight portion of the vehicle, the system of the present invention may provide an unobstructed view of an accident, which may include a good view of, for example, a license plate on another vehicle. Further, a camera positioned near the license plate receiving portion of the vehicle does not obstruct the vehicle operator's view, is relatively hidden such that it does not detract from the aesthetic appearance of the cockpit of the vehicle, and the camera is not easily blocked or disabled by occupants of the vehicle. Additionally, a camera mounted proximate the license plate receiving portion of a vehicle may be easily secured such that it is subject to a relatively lower amount of vibrations than would be a cockpit mounted camera.

Further, because, with the present invention, viewing, sampling and storing of visual data is not performed on a full-time basis, but is only begun when the vehicle comes close to another vehicle or object, or when the brakes are forcefully activated, the components of the system are subjected to relatively less wear and tear, thereby providing the system components with a relatively longer life and mean time between failure.

Still further, because the rate at which the image data is stored is varied as a function of the distance between the vehicle and another vehicle, the sampling or storage rate may be adjusted such that more information is obtained as the likelihood of an accident occurring increases.

### BRIEF DESCRIPTION OF THE DRAWINGS

In the drawing figures, which are not to scale, and which are merely illustrative, and wherein like reference characters denote similar elements throughout the several views:

FIG. 1 is a schematic diagram of an exemplary embodiment of the vehicle logging system of the present invention;

FIG. 2 is a schematic diagram of a vehicle having the vehicle logging system of the present invention;

FIG. 3 is a schematic diagram of a vehicle having another exemplary embodiment of the present invention;

FIG. 4 is a flow diagram depicting a method of logging vehicle data in accordance with the present invention; and

FIG. 5 is a schematic diagram of an exemplary embodiment of the present invention.

### DETAILED DESCRIPTION OF THE INVENTION

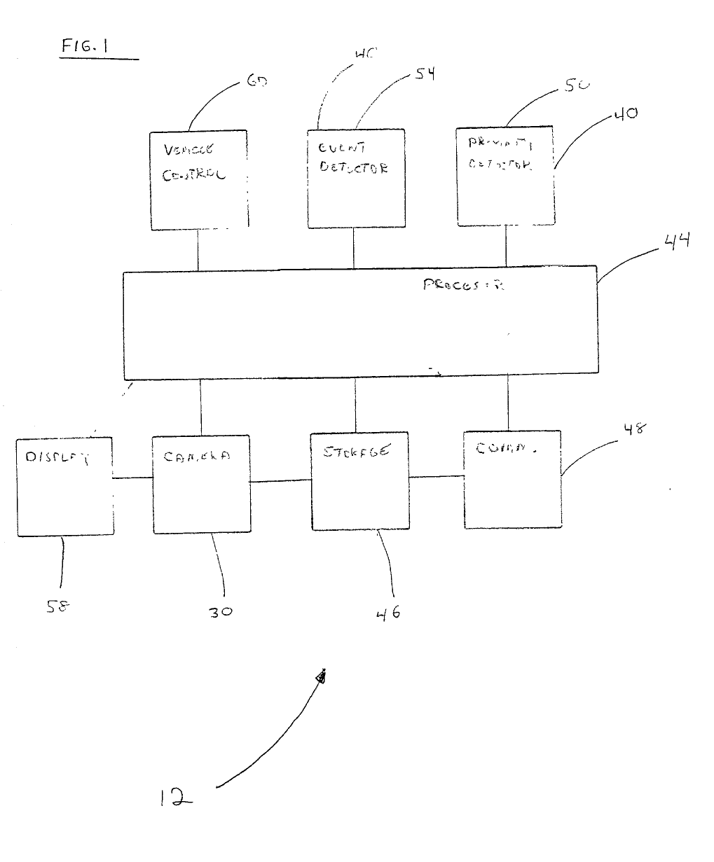

An exemplary embodiment of the vehicle logging system 12 of the present invention is shown in FIG. 1. Vehicle logging system 12 includes a processor unit 44 coupled to a camera unit 30. Processor unit 44 may be any type of microprocessor-based controller as is known in the art. Processor unit 44 may be a unit distinct from other processors in the vehicle, or may be a processor unit having shared functionality wherein functions related to the vehicle logging system 12 of the present invention, as well as other vehicle logging functions are performed. Camera unit 30 may be a digital or analog camera adapted to be placed on a vehicle. Camera unit 30 may also be a charge coupled device (CCD) type, as is known in the art. In an exemplary embodiment, the camera unit 30 may be a video-on-chip type unit, as in known in the art, wherein a camera unit is disposed on an integrated circuit chip. The specific type of camera used would be a matter of application specific design choice as would be determined by one skilled in the art.

Images obtained by camera unit 30 may be stored on storage unit 46. Storage unit 46 may be a ready access memory device or any other storage device adapted to store digital data. The specific type of storage device used would be a matter of application specific design choice as would be determined by one skilled in the art.

Vehicle logging system 12 may also include a detector unit 40 coupled to processor 44. Detector unit 40 may be a proximity detector 50 adapted to detect and sense the proximity of objects such as, for example, other vehicles. In an exemplary embodiment, proximity detector 50 may be a radio frequency (RF) type, ultrasonic type, electromotive force (EMF) type, or other type as is known in the art.

Detector unit 40 may also be an event detector 54, adapted to detect the occurrence of some vehicle related event, such as, for example, conditions related to a vehicle accident. Event detector 54 may be, for example, a sound detector, a sudden or hard-braking detector, an impact detector, or an airbag inflation detector. The specific type of detector device used would be a matter of application specific design choice as would be determined by one skilled in the art.

Additionally, detector unit 40 may include multiple detectors, with different detectors, as described above, being used in combination.

Vehicle logging system 12 may also include a communication unit 48. Communication unit 48 may be adapted to allow a third party entity, such as, for example, a police officer or Motor Vehicle Department personnel, to retrieve data stored from storage unit 46. Communication unit 48 may be a radio frequency device, an infrared device, or other device as is known in the art.

Vehicle logging system 12 may also have a display unit 58, adapted to display image data obtained from camera unit 30. In an exemplary embodiment, display unit 58 may be adapted such that an operator of a vehicle may be able to view images obtained by camera unit 30, the specific type of display device used being a matter of application specific design choice as would be determined by one skilled in the art. In an exemplary embodiment, display unit 58 may be a liquid crystal display flat panel device, or other similar type as is known in the art.

Vehicle logging system 12 may also interface with a vehicle control unit 60, such that vehicle related information and internal vehicle electronic data and signals, such as vehicle speed, may be obtained by vehicle logging system 12. This vehicle related information may be stored in storage unit 46 along with the image data.

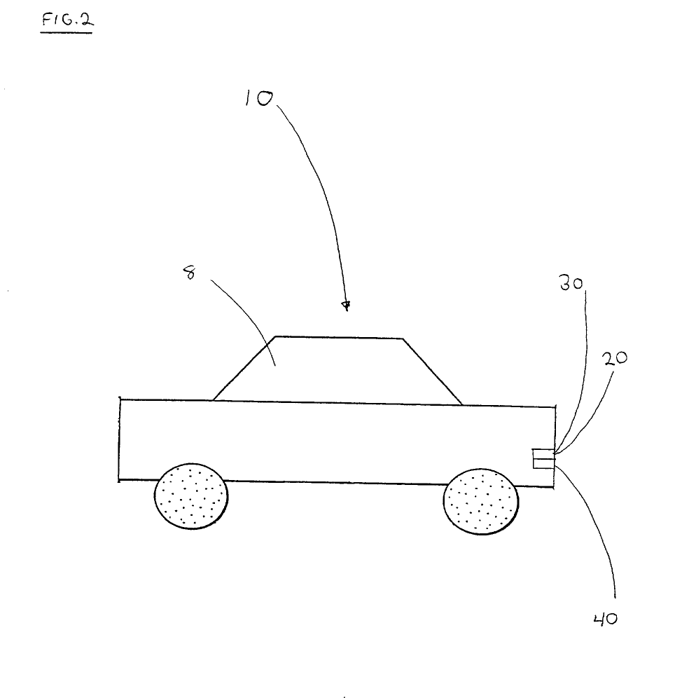

Referring to FIG. 2, vehicle 10 is shown, having a license plate receiving portion 20. In an exemplary embodiment of the invention, camera unit 30 may be disposed proximate license plate receiving portion 20. By disposing camera unit 30 proximate license plate receiving portion 20 of vehicle 10, camera unit 20 may obtain image data related to the occurrence of an event, or accident. An operator (not shown) in the cockpit 8 area of vehicle 10 does not have his field of view obstructed by camera unit 30, as it might be if camera unit 30 were to be positioned, for example, within cockpit 8. While vehicle 10 is shown as being an automobile, the present invention may be used on a variety of vehicles such as, but not limited to, automobiles, small trucks, commercial trucks, boats, buses, motorcycles and any other vehicles that may benefit from the logging of vehicle data.

Further, camera unit 30, when disposed proximate license plate receiving portion 20, may be securely mounted to vehicle 10 via shock mounts (not shown) such that vibrations may be minimized. This positioning of camera unit 30 also allows for a vehicle design whereby the cockpit 8 is free of poor aesthetic qualities that may result if camera unit 30 were to be positioned within cockpit 8.

Still further, by positioning camera unit 30 proximate license plate receiving portion 20, an improved field of view of other objects such as other vehicles may be provided. This improved field of view may also be beneficial to an operator (not shown) of the vehicle 10, if he uses display unit 58 to view images obtained by camera unit 30 to, for example, park or position a vehicle.

Detector unit 40 may also be disposed proximate license plate receiving portion 20, such that the distance between vehicle 10 and another object such as, for example, another vehicle, may be determined.

Further, while the invention is described above with camera unit 30 being disposed proximate license plate receiving portion 20 of the vehicle 10, camera unit 30 may alternatively be disposed proximate a bumper region, grill region, headlight region or taillight region (not shown) of vehicle 10. Any of these regions would tend to provide a relatively low vantage point for obtaining image data related to vehicle 10. The exact position camera unit 30 being an application specific matter of design choice for one skilled in the art.

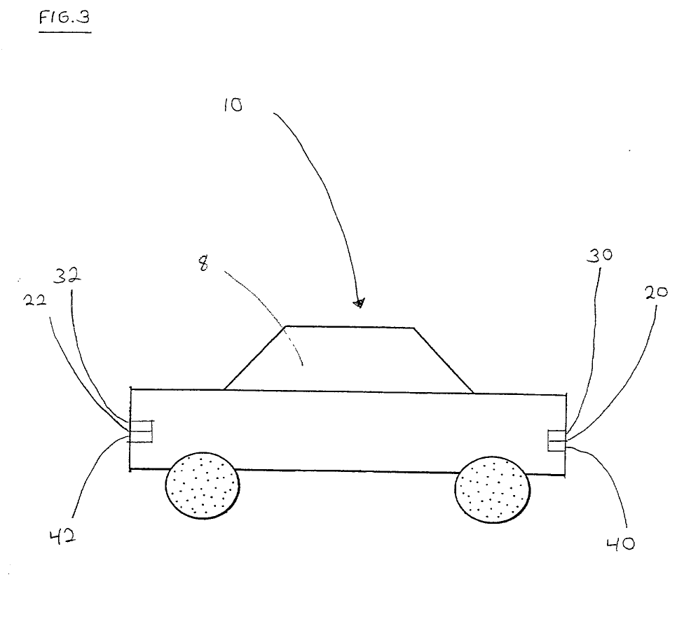

Referring to FIG. 3, in another embodiment of the invention, vehicle 10 may have first camera unit 30, disposed proximate first license plate receiving portion 20, and a second camera unit 32, disposed proximate second license plate receiving portion 22. Additionally, vehicle 10 may have first detector unit 40, disposed proximate first license plate receiving portion 20, and a second detector 42, disposed proximate second license plate receiving portion 22. By way of using first and second camera units 30, 32 and detector units 40, 42, image data may be obtained and stored from two different positions on vehicle 10. Accordingly, image data related to accidents and other vehicle events may be obtained from two different positions, providing additional data regarding the event. Additionally, more than two camera units 30, 32 may be used as an application specific matter of design choice.

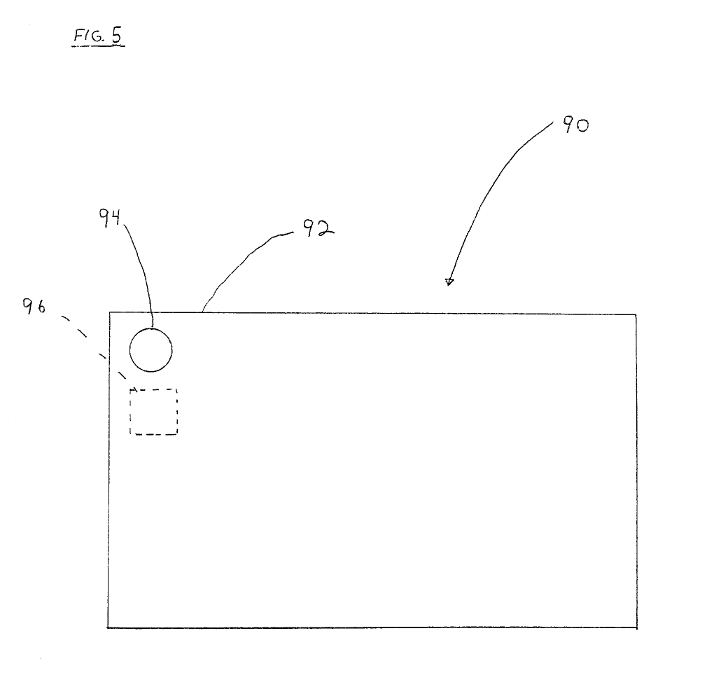

With reference to FIG. 5, an exemplary embodiment of the invention is shown by vehicle logging system 90. Vehicle logging system 90 may include a housing 92. A camera unit 94 may be disposed on housing 92, and processor unit 96 may be disposed at or in housing 92. Additionally, other portions of the invention such as storage unit 46 and communication unit 48, and first proximity detector 50 may be disposed on or in housing 92. One or all of these portions of the invention, however, may be disposed outside housing 92, and coupled to the portions that are in or on housing 92. In an exemplary embodiment, housing 92 may be adapted to fit in a license plate receiving portion 20 of a vehicle 10, and may be an actual vehicle license plate. Housing 92 may be formed of metal, plastic, or other materials as a matter of application specific design choice for one skilled in the art.

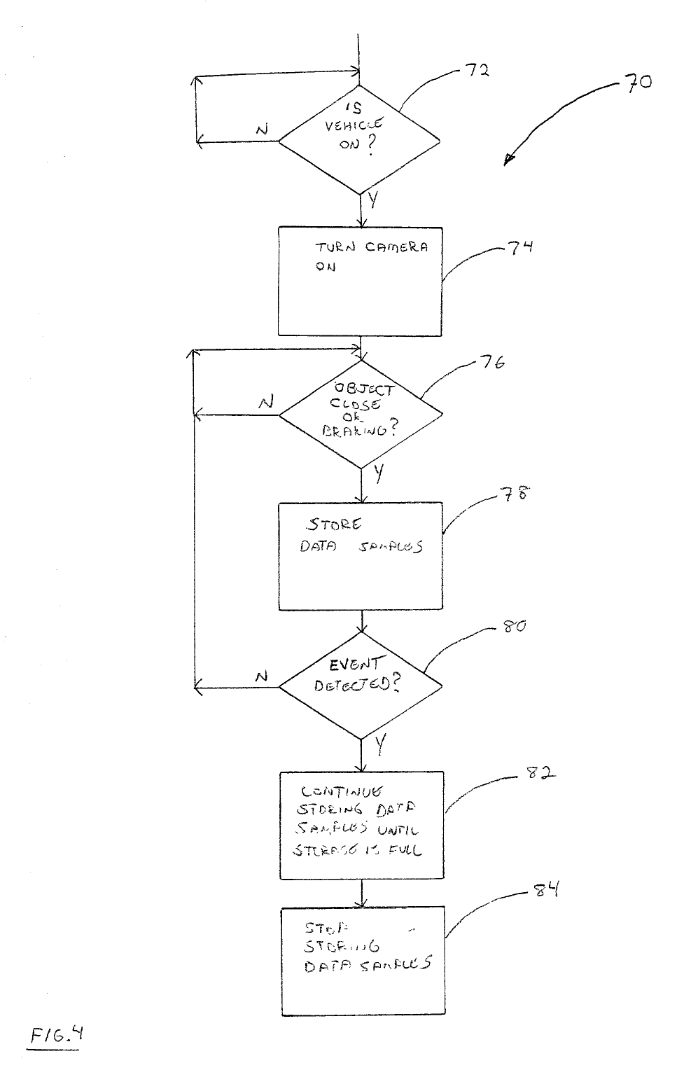

In use, vehicle logging system 12 may provide for the storage of image data. Turning to FIG. 4 (with reference back to FIGS. 1 and 2), an exemplary embodiment of the vehicle logging method 70 of the invention is shown. First, it is determined whether the vehicle 10 is started or turned on (as is shown in step 72). Next, when the vehicle is turned on, a camera unit 30 may be turned on, or put in active mode (as is shown in step 74). Next, it is determined via a detector unit 40 whether an object, such as another vehicle, is close, or within a certain distance of the vehicle 10 (as is shown in step 76). Additionally, a hard-braking condition, such as would result when the operator of the vehicle forcefully applies the brakes in an emergency situation, may be detected. If either a hard-braking condition, or a close object is detected, storage in storage unit 46 of the image data obtained by camera unit 30 may be started (as is shown in step 78). Image data may be stored sequentially in storage unit 46, with obtained images being saved at a periodic sampling rate. As a portion of storage unit 46 becomes full with image data, the storing process may continue with the oldest image data being overwritten by new image data.

Next, a detector unit 40 detects when an event occurs that is indicative of an accident (as is shown in step 80). Events that may be indicative of the occurrence of an accident include one or more of a loud sound, a sudden impact, the inflation of a vehicle airbag, or sudden or hard braking. Additionally, other events may be included as a matter of application specific design choice.

When an event indicative of an accident occurs, the storage of image data continues until the storage device (or that portion thereof dedicated to storing the image data) is full (as is shown in step 82). Once the storage device becomes full, the storing of image data is terminated (as is shown in step 84).

By way of the present system and method, component life and mean time between failure for components may be extended as storage of image data does not occur on a full-time basis, but only under certain circumstances, such as when an object is close, or the operator of the vehicle applies the brakes in a hard or forceful manner. At other times, when these circumstances are not present, the storing of image data is stopped, such that all of the components of the system are not in use.

Alternatively, while it is shown that camera unit 30 may turn on, or become active when the vehicle 10 is turned on (as is shown in step 74), an instant-on camera unit may also be used that would remain in an off state until an object is determined to be close, or hard-braking occurs, and then turns on substantially concurrently with the storing of image data (as is shown in step 78).

Further, the distance or proximity between the vehicle 10 and an object required to initiate the storage of image data may be varied as a function of the speed of the vehicle. A vehicle traveling relatively fast, for example, might require a larger trigger distance than a vehicle traveling at a relatively slower speed. Accordingly, processor 44 may be configured such that the trigger distance between the vehicle and an object may be varied as a function of the speed of the vehicle.

Still further, with the present invention, as stated above, the image data samples are stored in the storage device at a specific sample rate. By way of the present invention, the processor unit is configured such that the sample rate may be varied as a function of the distance between the vehicle and another object, such as another car. In this manner, the sampling rate may be increased as the vehicle and the object come closer together so that more data may be collected closer in time to the accident, where it may be more important to obtain additional data.

Moreover, in an exemplary embodiment of the invention, the method of logging vehicle data embodied by the invention does not require placement of a camera unit 30 proximate a license plate, bumper, grill, headlight or taillight region of vehicle 10, but in addition, may be used with camera unit 30 placed an a wide variety of positions on vehicle 10.

Thus, while there have been shown and described and pointed out fundamental novel features of the invention as applied to exemplary embodiments thereof, it would be understood that various omissions and substitutions and changes in the form and details of the disclosed invention may be made by those skilled in the art without departing from the spirit of the invention. It is the intention, therefore, to be limited only as indicated by the scope of the claim appended hereto.

What is claimed is:

1. An automatic vehicle logging system comprising:
a camera unit adapted to be disposed on a vehicle, said camera unit being adapted to obtain image data;
a processor unit coupled to said camera; and
a data storage unit coupled to said processor unit, said data storage unit being adapted to store samples of said image data; and
a detector unit coupled to said processor; said detector unit being adapted to detect driving condition data related to the driving conditions of the vehicle;
wherein said processor unit controls said storing of said image data by said data storage unit as a function of said driving condition data.

2. The system of claim 1, wherein said samples of image data are stored by said data storage unit at a sample rate, and wherein said processor unit varies said sample rate as a function of said driving condition data.

3. The system of claim 2, wherein said detector unit is a proximity sensor unit disposed on the vehicle, said proximity sensor unit being adapted to determine the distance between the vehicle and an object, and wherein said driving condition data includes said distance.

4. The system of claim 3, wherein the object is another vehicle.

5. The system of claim 3, wherein said processor unit varies said sample rate as a function of said distance between the vehicle and the object.

6. The system of claim 1, wherein said processor unit controls said storing of said samples of said image data such that said storing does not begin until initiated by a detected event.

7. The system of claim 6, wherein said detector unit is a proximity sensor unit disposed on the vehicle, said proximity sensor unit being adapted to determine the distance between the vehicle and an object, and wherein said detected event is when said distance is less than a trigger distance.

8. The system of claim 7, wherein said trigger distance is varied by said processor unit as a function of a speed of the vehicle.

9. The system of claim 6, wherein said detector unit is a hard-braking detector coupled to said processor unit, said hard-braking detector being adapted to detect when brakes on the vehicle are actuated in a forceful manner.

10. The system of claim 1, wherein said processor unit controls said storing of said samples of image data such that said storing stops when a portion of said storage device dedicated to storing said samples of image data becomes full.

11. The system of claim 1, wherein said processor unit controls said storing of said samples of image data such that said storing stops when triggered by a detected event.

12. The system of claim 11, wherein said detector unit is chosen from the group consisting of an impact detector, a hard braking detector, an airbag inflation detector, a proximity detector and a sound detector.

13. The system of claim 1, further comprising:
a communication unit coupled to said processor unit, said communication unit being adapted to communicate said stored samples of image data from said data storage unit to a third party entity.

14. The system of claim 1, further comprising a vehicle license plate adapted to be disposed at a license plate receiving portion of the vehicle;
wherein said camera unit is disposed in said vehicle license plate.

15. The system of claim 14, wherein said processor unit is disposed in said vehicle license plate.

16. The system of claim 1, wherein said camera unit is adapted to be disposed proximate a bumper portion of the vehicle.

17. The system of claim 1, wherein said camera unit is adapted to be disposed proximate a headlight portion of the vehicle.

18. The system of claim 1, wherein said camera unit is adapted to be disposed proximate a license plate receiving portion of the vehicle.

19. The system of claim 1, wherein said camera unit is adapted to be disposed outside of a cockpit portion of the vehicle.

20. The system of claim 1, wherein said camera unit is disposed in a license plate receiving portion of the vehicle.

21. The system of claim 1, further comprising:
a second camera unit adapted to be disposed on the vehicle, said second camera unit being adapted to obtain second camera image data;
said second camera unit being coupled to said processor unit;
said data storage unit being further adapted to store samples of said second camera image data; and
a second detector unit coupled to said processor; said second detector unit being adapted to detect driving condition data related to the driving conditions of the vehicle;
wherein said processor unit further controls said storing of said samples of said second camera image data to be stored by said data storage unit as a function of said driving condition data.

22. The system of claim 19, wherein said samples of image data are stored by said data storage unit at a sample rate, and wherein said processor unit varies said sample rate as a function of said driving condition data.

23. The system of claim 1, further comprising:
a second camera unit adapted to be disposed on the vehicle, said second camera unit being adapted to obtain second camera image data;
said second camera unit being coupled to said processor unit;
said data storage unit being further adapted to store samples of said second camera image data;
wherein said processor unit further controls said storing of said samples of said second camera image data to be stored by said data storage unit as a function of said driving condition data.

24. An automatic vehicle logging system comprising:
a camera unit disposed proximate a license plate receiving portion of a vehicle, said camera unit being adapted to obtain image data;
a processor unit coupled to said camera; and
a data storage unit coupled to said processor unit, said data storage unit being adapted to store samples of said image data;
wherein said processor unit controls said storing of said image data by said data storage unit.

25. The system of claim 24, further comprising:
a detector unit coupled to said processor, said detector unit being adapted to detect driving condition data related to the driving conditions of the vehicle;
wherein said processor unit controls said storing of said image data by said data storage unit as a function of said driving condition data.

26. An automatic vehicle logging system comprising:
a vehicle license plate;
a camera unit, said camera unit being adapted to obtain image data;
a processor unit coupled to said camera;
wherein said camera unit is disposed in said vehicle license plate and said processor unit is disposed in said vehicle license plate; and
a data storage unit coupled to said processor unit, said data storage unit being adapted to store samples of said image data;
wherein said processor unit controls said storing of said image data by said data storage unit.

27. A method for logging vehicle data, said method comprising:
obtaining samples of image data via a camera unit adapted to be disposed on a vehicle; and
detecting driving condition data related to driving conditions of the vehicle; and
storing samples of said image data in a data storage unit, said samples being stored at a sampling rate;
wherein said obtaining and storing are controlled by a processor unit coupled to said camera unit and said data storage unit as a function of said driving condition data.

28. The method of claim 27, further comprising:
varying said sampling rate via said processor unit as a function of said driving condition data.

29. The method of claim 28, further comprising:
determining the distance between the vehicle and an object via said detector unit;
wherein said detector unit is a proximity sensor and said driving condition data includes said distance.

30. The method of claim 29, wherein the object is another vehicle.

31. The method of claim 29, further comprising:
varying said sampling rate via said processor unit as function of said distance.

32. The method of claim 27, further comprising:
initiating said storing of image data when an event is detected by a detector unit.

33. The method of claim 32, further comprising:
determining the distance between the vehicle and an object via a proximity sensor, wherein said proximity sensor is said detector unit, and wherein said event is the occurrence of when said distance is less than a trigger distance.

34. The method of 33, further comprising:
varying said trigger distance as a function of a speed of the vehicle.

35. The method of claim 32, wherein said detector unit is a hard-braking detector coupled to said processor unit, said hard-braking detector being adapted to detect when brakes on the vehicle are actuated in a forceful manner.

36. The method of claim 32, further comprising:
stopping said sampling of image data when triggered by a detected event, said detected event being detected by a detector unit.

37. The method of claim 36, wherein said detector unit is chosen from the group consisting of an impact detector, a hard-braking detector, an airbag inflation detector, proximity detector and a sound detector.

38. The method of claim 27, further comprising:
communicating said stored samples of image data to a third party entity via a communication unit, said communication unit being coupled to said processor unit.

39. The method of claim 27, further comprising:
obtaining samples of second camera image data via a second camera unit adapted to be disposed on the vehicle;
storing samples of said second camera image data in a data storage unit, said samples being stored at a second sampling rate;
wherein said obtaining and said storing are controlled by a processor unit coupled to said second camera unit and said data storage unit as a function of said driving condition data.

40. The method of claim 39, further comprising:
varying said second sampling rate via said processor unit as a function of said driving condition data.

41. The method of claim 27, wherein said camera unit is disposed in a vehicle license plate and said processor unit is disposed in said vehicle license plate.

42. The method of claim 27, wherein said camera unit is adapted to be disposed proximate a bumper portion of the vehicle.

43. The method of claim 27, wherein said camera unit is adapted to be disposed proximate a headlight portion of the vehicle.

44. An automatic vehicle logging system comprising:
means for obtaining image data;
means for processing data coupled to said means for obtaining image data; and
means for storing samples of said image data, said means for storing samples of said image data being coupled to said means for processing; and
means for detecting driving condition data related to the driving conditions of the vehicle, said means for detecting driving condition data related to the driving conditions of the vehicle being coupled to said means for processing;
wherein said means for processing controls said storing of said image data by said means for storing as a function of said driving condition data.

45. The system of claim 44, wherein said samples of image data are stored by said means for storing samples of image data at a sample rate, and wherein said means for processing varies said sample rate as a function of said driving condition data.
